(19) United States
(12) Patent Application Publication
(10) Pub. No.: US 2026/0237568 A1
(43) Pub. Date: Aug. 13, 2026

(54) ELECTROLYTIC CAPACITOR

(71) Applicant: Panasonic Intellectual Property Management Co., Ltd., Osaka (JP)

(72) Inventors: MASAHIRO UEDA, Osaka (JP); TAKASHI UMEMOTO, Osaka (JP)

(21) Appl. No.: 19/160,849

(22) PCT Filed: Mar. 6, 2024
(86) PCT No.: PCT/JP2024/008415

§ 371 Date: Aug. 28, 2025

(30) Foreign Application Priority Data
Mar. 24, 2023 (JP) 2023-048158

(51) Int. Cl. H01G 9/052; H01G 9/15

(52) U.S. Cl. CPC H01G 9/052; H01G 9/15

(57) ABSTRACT

An electrolytic capacitor includes an anode body, a dielectric layer covering at least a part of the anode body, and a solid electrolyte layer covering at least a part of the dielectric layer. The anode body is a sintered body of valve metal particles. A total number of defects of the dielectric layer to be found is less than or equal to four in a condition that six regions are arbitrarily set in a surface of the anode body, and each of the six regions is observed in a visual field of 100 μm².

### TECHNICAL FIELD

The present disclosure relates to an electrolytic capacitor.

### BACKGROUND

Patent Literature 1 proposes “a method for producing a porous niobium material, the method including: anodizing a surface of a base material with an electrolytic solution containing hydrofluoric acid when producing a porous niobium material having a porous oxide film on the surface of the base material composed of niobium”. Patent Literature 1 also proposes “a porous niobium material including a porous layer having a pore diameter of 10 nm to 20 nm on a barrier layer, in which a pore portion or a petal-like defect portion having a pore diameter of 0.2 μm to 1 μm or more is not formed”.

### CITATION LIST

### Patent Literature

PTL 1: Unexamined Japanese Patent Publication No. 2006-83425

### SUMMARY

An aspect of the present disclosure relates to an electrolytic capacitor. The electrolytic capacitor includes an anode body, a dielectric layer covering at least a part of the anode body, and a solid electrolyte layer covering at least a part of the dielectric layer. The anode body is a sintered body of valve metal particles. A total number of defects of the dielectric layer to be found is less than or equal to four in a condition that six regions are arbitrarily set in a surface of the anode body, and each of the six regions is observed in a visual field of 100 μm².

When a sintered body of valve metal particles is used as the anode body, defects in the dielectric layer covering at least a part of the anode body are reduced.

### BRIEF DESCRIPTION OF THE DRAWINGS

FIG. 1 is a view illustrating an example of how to set arbitrary six regions in an anode body of an electrolytic capacitor according to an exemplary embodiment of the present disclosure.

FIG. 2 is a schematic cross-sectional view illustrating the electrolytic capacitor according to the exemplary embodiment of the present disclosure.

FIG. 3 is a scanning electron microscope (SEM) image showing defects formed in a dielectric layer.

### DESCRIPTION OF EMBODIMENT

Patent Literature 1 proposes usage of an electrolytic solution containing bydrofluoric acid, but hydrofluoric acid has a large influence on a human body and is difficult to handle. In Patent Literature 1, a high-purity niobium foil is used, but since the sintered body of the valve metal particles is porous and has a very large surface area, it is difficult to eliminate defects as in the case of the high-purity niobium foil.

Hereinafter, the exemplary embodiments of the present disclosure will be described with reference to examples, but the present disclosure is not limited to examples to be described below. In the following description, specific numerical values, materials, and the like may be exemplified, but other numerical values, materials, and the like may be applied as long as the effect of the present disclosure can be obtained. Note that constituent elements of known capacitors may be applied to constituent elements other than the portions characteristic of the present disclosure. In this specification, the “range of the numerical value A to the numerical value B” includes the numerical value A and the numerical value B. When a plurality of materials is exemplified, one of the materials may be selected and used alone, or two or more of the materials may be used in combination.

An electrolytic capacitor (hereinafter, also referred to as a “capacitor (C)”) according to an exemplary embodiment of the present disclosure includes an anode body, a dielectric layer covering at least a part of the anode body, and a solid electrolyte layer covering at least a part of the dielectric layer.

The minimum unit of the electrolytic capacitor including the anode body, the dielectric layer, and the solid electrolyte layer may be referred to as a “capacitor element”. Therefore, the capacitor (C) is a concept including both the electrolytic capacitor and the capacitor element.

In the capacitor (C), the anode body is a sintered body of valve metal particles. Further, in the capacitor (C), the total number of defects (total of six regions) of the dielectric layer to be found is limited to less than or equal to four in a condition that six regions are arbitrarily set in the surface of the anode body, and each of the six regions is observed in a visual field of 100 μm².

When a sintered body of valve metal particles is used as the anode body of the electrolytic capacitor, the leakage current increases when the number of defects in the dielectric layer covering at least a part of the anode body is large. When the leakage current increases, the reliability of the electrolytic capacitor cannot be improved, and it is difficult to increase the capacitance and the life of the electrolytic capacitor.

On the other hand, when the total number of defects to be found in the dielectric layer is limited to less than or equal to four in a condition that any six regions in the surface of the anode body are observed in a visual field of 100 μm², the leakage current is remarkably suppressed. Therefore, the reliability of the electrolytic capacitor is improved, and a large capacitance and a long life can be achieved.

Here, the defect is a petal-like crack formed in the dielectric layer, which causes deterioration in long-term reliability. The dielectric layer is required to have an amorphous structure from the viewpoint of improving insulating properties. However, the portion where the defect is formed usually has crystallinity. The defect may be referred to as a crystalline defect. The size of the defect slightly changes, and a petal-like crack also increases in a defect having a large size.

The portion where the defect is formed has crystallinity, and thus has an appearance different from that of the portion having an amorphous structure. Therefore, by performing processing such as binarization on the image in which the defect is observed, the defect and the portion other than the defect can be divided.

The method for observing each of arbitrary six regions in the surface of the anode body in a field of view of 100 μm² is not particularly limited, but for example, six regions of 100 μm² in the surface of the anode body may be photographed by a scanning electron microscope (SEM).

In a condition that arbitrary six regions in the surface of the anode body are observed in a field of view of 100 μm², the total number of defects of the dielectric layer found in the six regions is preferably as small as possible, and is preferably one or less. It is most preferable that no defect of the dielectric layer is found in a condition that arbitrary six regions in the surface of the anode body are observed in a visual field of 100 μm².

The shape of the anode body is, for example, a rectangular parallelepiped shape. An anode wire is planted from the first main surface of the rectangular parallelepiped shape of the anode body. The arbitrary six regions are set so as to include the centers of the six regions respectively when the second main surface (one of the four second main surfaces) intersecting the first main surface of the rectangular parallelepiped shape is divided into six equal regions. The second main surface is equally divided into a matrix of two rows×three columns. A direction in which three columns are arranged is defined as a longitudinal direction.

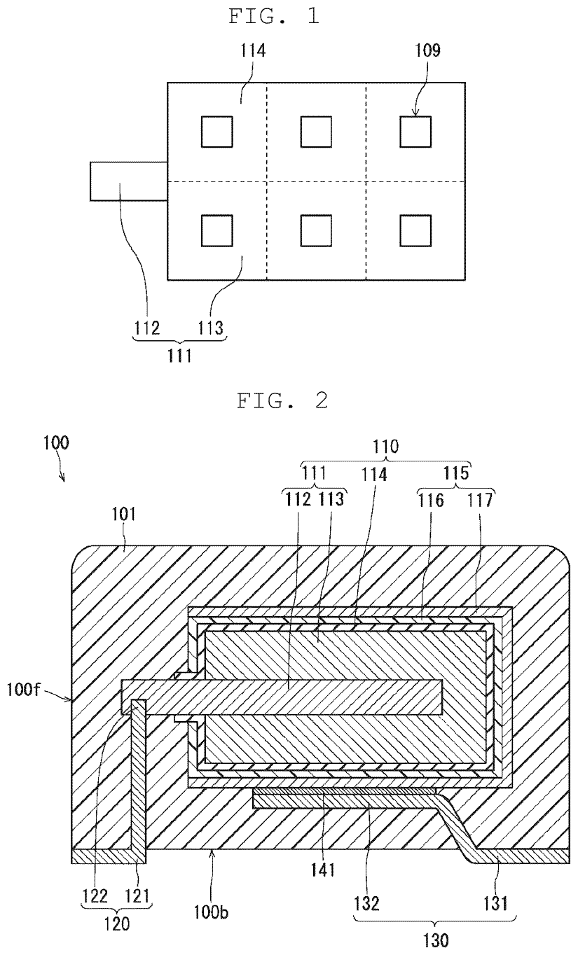

FIG. 1 illustrates an example of how to set arbitrary six regions. Anode part 111 shown in FIG. 1 includes anode wire 112 and rectangular parallelepiped shape of anode body 113. A dielectric layer is formed on a surface of anode body 113. Assuming that the main surface on which anode wire 112 is planted is the first main surface, arbitrary six regions (observation regions) 109 can be selected on one second main surface as in the illustrated example. Arbitrary six regions (observation regions) 109 are set so as to respectively include the centers of six rectangular regions equally divided into a matrix of 2 rows×3 columns. Each observation region 109 may have a rectangular shape, a circular shape, or other shapes.

The dielectric layer with fewer defects is formed, for example, by cleaning the anode body using a cleaning liquid before forming the dielectric layer. The anode body is a sintered body of valve metal particles. The sintered body of valve metal particles is formed by sintering a porous molded body obtained by molding particles containing a valve metal. Particles containing a valve metal and molded bodies thereof normally contain impurities such as dissimilar metals and carbon residues. It has not been considered that there is a correlation between the impurity amount and the number of defects in the dielectric layer, but there is actually a correlation. In other words, it is possible to form a dielectric layer with fewer defects by sufficiently cleaning the sintered body using the cleaning liquid. The cleaned anode body is normally dried. The drying is performed, for example, at a temperature ranging from 60° C. to 150° C., inclusive, for a period from 5 minutes to 60 minutes, inclusive.

As the cleaning liquid, an acidic solution, an organic solvent, or the like is used. As the cleaning liquid, a mixed liquid of an acidic solution and an organic solvent may be used. Examples of the organic solvent include alcohols (such as ethanol), ketones (acetone, ethyl methyl ketone, and the like), nitriles (such as acetonitrile), esters (such as ethyl acetate), ethers (diethyl ether, tetrahydrofuran, and the like), amides (dimethylformamide, N-methylpyrrolidone, etc.), and sulfoxides (such as dimethyl sulfoxide). The cleaning liquid may contain one kind of organic solvent or two or more kinds in combination. Examples of the acidic solution include a sulfuric acid aqueous solution, a hydrochloric acid aqueous solution, a nitric acid aqueous solution, and a phosphoric acid aqueous solution. The acid may be used singly or in combination of two or more kinds thereof. The concentration of the acid in the cleaning liquid may range from 1% by mass to 30% by mass, inclusive.

Hereinafter, the constituent elements of the capacitor (C) will be described more specifically. The capacitor (C) includes at least one capacitor element. A capacitor element includes an anode part and a cathode part. The cathode part includes a solid electrolyte layer. The anode part includes an anode body, and a dielectric layer is formed on a surface of the anode body.

### (Anode Body)

The anode body is, for example, a sintered body of valve metal particles. The sintered body of the valve metal particles is porous as a whole. Since the porous anode body has a large surface area, a high capacitance can be obtained.

The valve metal particles are particles such as a valve metal, an alloy containing a valve metal, and a metal compound containing a valve metal. The valve metal particles may be used singly or in combination of two or more kinds thereof. Examples of the valve metal include aluminum, tantalum, niobium, and titanium. Among them, tantalum is preferable as the valve metal constituting the sintered body.

The anode body has a cathode formation part. The cathode formation part of the anode body has a surface on which the cathode part including the solid electrolyte is formed. For example, an anode wire used for electrical connection with an anode external electrode is connected to the anode body. The shape of the anode body is, for example, a rectangular parallelepiped shape. An anode wire is planted from the first main surface of the rectangular parallelepiped shape of the anode body. A part of the anode wire is embedded in the anode body, and the remaining part of the anode wire protrudes outward from the first main surface. The remaining part of the anode wire is connected to, for example, an anode lead terminal continuous with the external terminal.

### (Dielectric Layer)

The dielectric layer is an insulating layer serving as a dielectric. The dielectric layer may be formed by anodizing the valve metal of the surface of the anode body. For example, when tantalum particles are used as the valve metal particles, the dielectric layer formed by anodic oxidation contains Ta₂O₅. As a result, an anode element composed of an anode body and a dielectric layer is obtained. Since the anode body is porous, the anode element is also porous. The porosity of the anode element ranges, for example, from 45% to 75%, inclusive, and may range from 55% to 65%, inclusive. The porosity of the anode element is determined, for example, from the amount of pure water pushed away when the anode element is immersed in pure water and the apparent volume determined from the dimension of the outer shape of the anode element (Archimedes method)

### (Capacitor Element)

The capacitor element includes an anode body, a dielectric layer, and a cathode part covering at least a part of the dielectric layer. The cathode part includes at least a solid electrolyte layer, and may include a cathode lead-out layer. The cathode part normally includes a solid electrolyte layer covering at least a part of the dielectric layer, and a cathode lead-out layer covering at least a part of the solid electrolyte layer.

### (Solid Electrolyte Layer)

The solid electrolyte layer is formed on the cathode formation part of the anode body with the dielectric layer interposed therebetween. The solid electrolyte layer may cover the dielectric layer in a layered manner. The solid electrolyte layer may be a stacked body of two or more layers of different solid electrolytes.

The solid electrolyte constituting the solid electrolyte layer is not particularly limited, and a solid electrolyte used in a known electrolytic capacitor may be applied. The solid electrolyte is disposed so as to cover at least a part of the dielectric layer. The solid electrolyte may be formed using, for example, at least one of a manganese compound and a conductive polymer. The conductive polymer includes, for example, a conjugated polymer and a dopant. The conductive polymer may include a self-doped conductive polymer.

Examples of the conjugated polymer include polypyrrole, polythiophene, polyaniline, and derivatives thereof. These may be used singly or in combination of two or more kinds thereof. The conjugated polymer may be a copolymer of two or more monomers. The derivative of the conjugated polymer means a polymer having the conjugated polymer as a basic skeleton. Examples of derivatives of polythiophene include poly(3,4-ethylenedioxythiophene).

The dopant can be selected according to the conjugated polymer, and a known dopant may be used. Examples of the dopant include a compound capable of generating an anion (for example, aromatic sulfonic acid (naphthalenesulfonic acid, p-toluenesulfonic acid, and the like) or a salt thereof), a polyanion (for example, polymer-type polyanions (such as polystyrene sulfonic acid)), and the like. Examples of solid electrolytes include polypyrrole doped with aromatic sulfonic acid and poly(3,4-ethylenedioxythiophene) (PEDOT) doped with polystyrene sulfonic acid (PSS).

The solid electrolyte layer may be formed by, for example, polymerizing a precursor of a conjugated polymer (raw material monomer or the like) on the dielectric layer in the presence of a dopant as necessary. The solid electrolyte layer may be formed by applying a liquid composition containing a conjugated polymer (and a dopant as necessary) to the dielectric layer and then drying the liquid composition.

### (Cathode Lead-Out Layer)

The cathode lead-out layer is a conductive layer. The cathode lead-out layer is disposed so as to cover at least a part of the solid electrolyte layer. The configuration of the cathode lead-out layer is not particularly limited, and a known cathode lead-out layer may be adopted. The cathode lead-out layer may include, for example, a carbon layer formed on the solid electrolyte layer and a metal particle-containing layer formed on the carbon layer. The carbon layer may contain conductive carbon material such as graphite, and resin. The metal particle-containing layer may contain metal particles (for example, silver particles) and a resin. The metal particle-containing layer may be a silver particle-containing layer formed of a silver paste containing silver particles or silver alloy particles.

The cathode lead-out layer may include a metal foil. As the metal foil, a valve metal (aluminum, tantalum, niobium, and the like) or an alloy containing a valve metal may be used. If necessary, the surface of the metal foil may be roughened. The surface of the metal foil may be provided with an anodization film, or may be provided with a film of metal different from the metal forming the metal foil (dissimilar metal), or a nonmetal film. Examples of the dissimilar metals and nonmetals include metals such as titanium and nonmetals such as carbon (conductive carbon and the like).

The cathode lead-out layer may be electrically connected to one end portion of the cathode lead terminal continuous with the external terminal. For example, a conductive adhesive is applied to the cathode lead-out layer, and the cathode lead terminal is joined to the cathode lead-out layer via the conductive adhesive. The anode wire protruding from the anode body may be electrically connected to one end portion of the anode lead terminal.

The other ends of the anode lead terminal and the cathode lead terminal are drawn out of a resin exterior body or the case. The other end of each of the anode lead terminal and the cathode lead terminal exposed from the resin exterior body or the case is used for solder connection with a substrate on which a solid electrolytic capacitor is to be mounted. At least one end surface of the anode part and the cathode part may be exposed from the outer surface of a sealing body to be electrically connected to the external electrode without pulling out a part of the anode lead terminal and the cathode lead terminal.

The capacitor element is sealed by the resin exterior body or the case. For example, the capacitor element may be housed in a mold, and the capacitor element may be sealed with a resin exterior body by a transfer molding method, a compression molding method, or the like using a material resin (for example, uncured thermosetting resins and fillers) of the exterior body. At this time, the other ends of the anode lead terminal and the cathode lead terminal connected to the anode wire drawn out from the capacitor element are exposed from the mold.

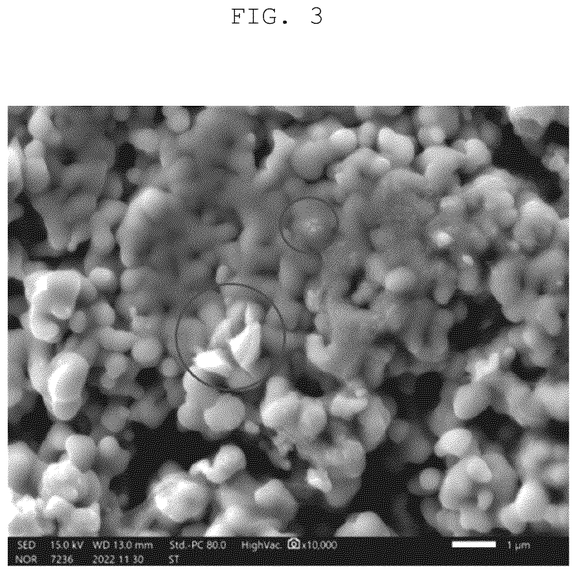

FIG. 2 is a cross-sectional view schematically showing an example of the solid electrolytic capacitor according to the present disclosure. Solid electrolytic capacitor 100 shown in FIG. 2 includes capacitor element 110, anode lead terminal 120, cathode lead terminal 130, exterior body 101, and conductive layer 141. Capacitor element 110 includes anode part 111, dielectric layer 114, and cathode part 115. Anode part 111 includes anode body 113 and anode wire 112. Anode body 113 is a sintered body of valve metal particles and has a rectangular parallelepiped shape. Dielectric layer 114 is formed on a surface of anode body 113. A part of anode wire 112 protrudes from the first end surface of anode body 113 toward front surface 100f of solid electrolytic capacitor 100. The other part of anode wire 112 is buried in anode body 113.

Cathode part 115 includes solid electrolyte layer 116 disposed so as to cover at least a part of dielectric layer 114, and cathode lead-out layer 117 formed on solid electrolyte layer 116. Cathode lead-out layer 117 includes, for example, a carbon layer formed on solid electrolyte layer 116 and a metal particle-containing layer formed on the carbon layer. The metal particle-containing layer is formed using, for example, a metal paste (silver paste or the like).

Anode lead terminal 120 includes anode terminal part 121 and lead connection part 122. Anode terminal part 121 is exposed at bottom surface 100b of solid electrolytic capacitor 100. Lead connection part 122 is connected to anode wire 112. Cathode lead terminal 130 includes cathode terminal part 131 and connection part 132. Cathode terminal part 131 is exposed on bottom surface 100b of solid electrolytic capacitor 100. Connection part 132 is electrically connected to cathode lead-out layer 117 by conductive layer 141.

### EXAMPLES

Hereinafter, the present invention will be specifically described based on Examples and Comparative Examples, but the present invention is not limited to only the following Examples.

### Example 1

### (1) Production of Capacitor Element

### (i) Preparation of Anode Body

Tantalum (Ta) particles (Ta powder) were used as valve metal particles. The Ta powder was molded into a rectangular parallelepiped shape so that one end of an anode wire made of Ta was embedded in the Ta powder, and then the molded body was sintered in vacuum. As a result, an anode part including a sintered body (anode body) of a molded body of porous Ta particles and an anode wire which is partially embedded in the sintered body (anode body) and has the remainder protruding from the first main surface of the anode body was obtained.

The anode part including the sintered body (anode body) and the anode wire was cleaned using isopropanol (IPA) as a cleaning liquid, and then dried at 150° C. for 30 minutes.

### (ii) Formation of Dielectric Layer (Anode Element)

106 cleaned anode parts were arranged in a line at regular intervals, and an anode wire was welded to an elongated plate-like first electrode. A part of the anode body and the anode wire were immersed in an anodizing solution in an anodizing tank entirely made of glass, and in a state where a second electrode made of Ta was immersed in the anodizing solution, a DC voltage was applied between the first electrode and the second electrode to oxidize the surface of the anode body, thereby forming a dielectric layer. As the anodizing solution, a 0.06 mass % aqueous solution of nitric acid was used. A temperature of the anodizing solution was 60° C. The DC voltage was 15 V and was applied for 10 hours. After formation, it was dried at 100° C. for 10 minutes. Thus, a uniform anodization coating film (thickness of about 30 nm) of tantalum oxide (Ta₂O₅) was formed as the dielectric layer on the surface of the anode body and a part of a surface of the anode wire.

(iii) Formation of Solid Electrolyte Layer

A mixed solution was prepared by dissolving 3,4-ethylenedioxythiophene and polystyrene sulfonic acid in ion-exchanged water. While the mixed solution was being stirred, iron (III) sulfate (oxidizing agent) dissolved in ion-exchanged water was added to perform a polymerization reaction. After the reaction, the obtained reaction solution was dialyzed to remove unreacted monomers and an excessive oxidant. A predetermined amount of moisture was removed from the resulting mixture, and isopropanol (IPA) was added to obtain a liquid dispersing element containing polyethylene dioxythiophene doped with polystyrene sulfonic acid (PEDOT/PSS). The anode body on which the dielectric layer was formed was impregnated with the liquid dispersing element for 5 minutes, and then dried at 150° C. for 30 minutes to form a solid electrolyte layer on the dielectric layer.

### (iv) Formation of Carbon Layer

A dispersion liquid (carbon paste) in which carbon particles were dispersed in water was applied to the solid electrolyte layer, and then heated at 200° C. to form a carbon layer on the surface of the solid electrolyte layer.

### (v) Formation of Metal Particle-Containing Layer

A silver paste containing silver particles, a binder resin, and a solvent was applied to the surface of the carbon layer. Thereafter, heating was performed at 200° C. to form a metal particle-containing layer, thereby obtaining a capacitor element.

### (2) Preparation of Electrolytic Capacitor

A conductive adhesive was applied to the metal particle-containing layer of the capacitor element, and the cathode lead terminal and the metal particle-containing layer were joined. The anode lead and an anode lead terminal were joined by resistance welding. Next, the capacitor element to which each lead terminal was joined was housed in a mold and sealed with the material of the exterior body (thermosetting resin composition) by a transfer molding method. In this way, electrolytic capacitor A1 having a rated voltage Rv of 35 V was produced.

### Example 2

Electrolytic capacitor A2 was produced in the same manner as in Example 1 except that an anode part constituted by a sintered body (anode body) and an anode wire was cleaned using, as a cleaning liquid, a mixed solvent obtained by mixing isopropanol (IPA) and distilled water at a mass ratio of 60:40.

### Example 3

Electrolytic capacitor A3 was produced in the same manner as in Example 1 except that an anode part constituted by a sintered body (anode body) and an anode wire was cleaned using, as a cleaning liquid, a solution obtained by mixing isopropanol (IPA) and a sulfuric acid aqueous solution (sulfuric acid concentration: 1% by mass) at a mass ratio of 60:40.

### Comparative Example 1

Electrolytic capacitor B1 was produced in the same manner as in Example 1 except that an anode part constituted by a sintered body (anode body) and an anode wire was cleaned using, as a cleaning liquid, distilled water.

### Comparative Example 2

Electrolytic capacitor B2 was produced in the same manner as in Example 1 except that the anode part was not cleaned.

### <<Evaluations>>>

The electrolytic capacitors obtained in Examples and Comparative Examples were dried at 170° C. for three hours, and then cooled to 20° C.±5° C. in a drying chamber. The solid electrolytic capacitor in this state was used to perform the following evaluation. μ was measured in an environment of 20° C. using an LCR meter for 4-terminal measurement. Next, a rated voltage (35 V) was applied to the electrolytic capacitor in an environment at a temperature of 125° C. for 2000 hours (reliability test). Thereafter, capacitance C1 (mΩ) was measured in the same manner as described above. Then, the ratio (%) of the difference (AC) between C0 and C1 to C0 was obtained as a capacitance deterioration rate. Evaluation results are shown in Table 1.

TABLE 1

| | Number of | Capacitance | |
|---|---|---|---|
| Electrolytic | defects | deterioration | |
| capacitor | observed | rate (%) | Cleaning liquid |
| A1 | 4 | 9 | IPA |
| A2 | 1 | 5 | IPA/distilled water |
| A3 | 0 | 1 | IPA/sulfuric acid aqueous |
| | | | solution |
| B1 | 7 | 30 | Distilled water |
| B2 | 20 | 95 | No cleaning |

FIG. 3 shows one of SEM images of a dielectric layer of solid electrolytic capacitor B1 of Comparative Example 1. In the SEM image, a petal-like crack is observed in a region surrounded by a circle.

### INDUSTRIAL APPLICABILITY

The electrolytic capacitor of the present disclosure has low leakage current and high reliability. Therefore, the solid electrolytic capacitor is suitable for use in connection with an electronic circuit, and can suppress malfunction of the electronic circuit in such use. However, the application of the electrolytic capacitor is not limited to these.

### REFERENCE MARKS IN THE DRAWINGS

100 electrolytic capacitor
109 observation region
110 capacitor element
111 anode part
112 anode wire
113 anode body
114 dielectric layer
115 cathode part
116 solid electrolyte layer
117 cathode lead-out layer
120 anode lead terminal
121 anode terminal part
122 lead connection part
130 cathode lead terminal
131 cathode terminal part
132 connection part
141 conductive layer

1. An electrolytic capacitor comprising:
an anode body;
a dielectric layer covering at least a part of the anode body; and
a solid electrolyte layer covering at least a part of the dielectric layer, wherein:
the anode body is a sintered body of valve metal particles, and
a total number of defects of the dielectric layer to be found is less than or equal to four in a condition that six regions are arbitrarily set in a surface of the anode body, and each of the six regions is observed in a visual field of 100 μm².

2. The electrolytic capacitor according to claim 1, wherein a total number of the defects of the dielectric layer to be found is less than or equal to one in the condition that each of the six regions is observed in a visual field of 100 μm².

3. The electrolytic capacitor according to claim 1, wherein no defect of the dielectric layer is found in the condition that each of the six regions is observed in a visual field of 100 μm².

4. The electrolytic capacitor according to claim 1, wherein:
the anode body has a rectangular parallelepiped shape,
the anode body includes an anode wire planted from a first main surface of the anode body, and
each of the six regions is set to include a center of corresponding one of six equal regions obtained by equally dividing a second main surface of the rectangular parallelepiped shape, the second main surface intersecting the first main surface.
